(19) United States
(12) Patent Application Publication
(10) Pub. No.: US 2007/0136228 A1
(43) Pub. Date: Jun. 14, 2007

(54) Systems and methods for check-in processing

(76) Inventor: Lars Henning Petersen, Copenhagen (DK)

Correspondence Address: TRAN & ASSOCIATES, 6768 MEADOW VISTA CT., SAN JOSE, CA, 95135, US

(21) Appl. No.: 11/301,562

(22) Filed: Dec. 13, 2005

(51) Int. Cl. G06F 17/30

(52) U.S. Cl. 707/1

(57) ABSTRACT

Systems and methods are disclosed to provide remote check-in for one or more targeted events for a user by tracking a check-in time for each targeted event using a queue; and scheduling a transmission of a message to the user through a wireless device a predetermined time before the targeted event starts.

### BACKGROUND

This invention relates generally to automatic check-in processing.

In many travel related operations, travelers or customers wait in lines to be served or to be cleared for entry to the desired services. When many people desire a particular service, such congestion is a common source of irritation for travelers and customers alike. For example, at an airport, passengers need to check-in and then they wait for their seat number to be before they can board a plane and the congestion at airports may be so severe that it can lead to missed flights and ensuing difficulties. Likewise, in other industries, such as the hotel industry, employees provide check-in processing, paperwork printing, and issuing keys to particular individuals traveling. Similarly, at a tourist attraction spot or at an event such as a concert, customers with tickets wait in line until they are called for admittance.

This process is used in ticketless situations such as filled restaurants where customers show up and wait in line until others ahead of the line have been served. To address this need, CommTech Wireless (http://www.commtechwireless.com) provides a guest call restaurant paging system called the Patron Pager system. In this system, if a patron has to wait for either their table or to collect their meal, they can be issued a pager and invited to enjoy a drink while they wait and when their meal or table is ready, bistro staff simply enter the pager number into the restaurant paging system. The pager can flash, beep or vibrate (or any combination of the three) to let patrons know that the wait is up. The guest call restaurant paging system is a great way to increase turnover, increase customer satisfaction and reduce walk-aways. CommTech also provides SMS Exchange, which is an SMS software package that enables users to send text messages directly to wide area pagers or cellular phones (as an SMS). SMS Exchange can intercept email traffic and dispatch the email directly to a mobile device (such as a pager or cellular phone).

### SUMMARY

In one aspect, systems and methods are disclosed to provide remote check-in for one or more targeted events for a user by tracking a check-in time for each targeted event using a queue; and scheduling a transmission of a message to the user through a wireless device a predetermined time before the targeted event starts.

In another aspect, a system to provide remote check-in for one or more targeted events for a user includes an event database to track a check-in time for each targeted event; a queue coupled to the event database and having one entry for each targeted event; and a scheduler coupled to the event database and the queue, the scheduler sending a message to the user through a wireless device a predetermined time before the targeted event starts.

Advantages of the above system may include one or more of the following. The system provides an inexpensive and convenient virtual alternative to traditional physical waiting in-line approach to a particular event. Travelers can grab a few hours at a venue of choice for rest and relaxation, and only show up in line when needed. Thus, travelers can maximize their enjoyment of their visits. Travelers only need to enter a targeted event request, and the system responds by fully automatically and rapidly sends reminders when the time for a targeted event is almost due and finds alternatives and options available for the traveler to keep him or her occupied meanwhile. The system generates individualized suggestions for the particular traveler, regarding acceptable or desirable price tradeoffs between availability, proximity and cost on the one hand and time and convenience on the other. The system can store an individualized policy for each traveler or, for each group of travelers who share some common characteristic (e.g., employed at a similar level in the same company), and a travel policy can be tiered, to automatically accommodate the various levels of employees who may travel or for the kind of travel for an individual or a group. The system operates with user's cell phone and does not require special or dedicated expensive equipment. The system uses off-the-shelf cellular phones with long battery life and long transmission range. These and other advantages and features of the present invention shall hereinafter appear, and for the purposes of illustration, but not limitation, exemplary embodiments of the present invention shall hereinafter be described.

### BRIEF DESCRIPTION OF THE DRAWINGS

FIG. 1 shows an exemplary process to provide a remote check-in reminder for one or more targeted events for a user.

FIG. 2 shows an exemplary system to provide remote check-in for users.

FIG. 3 shows an exemplary user interface (UI) to capture relevant information about a targeted event.

FIG. 4 shows an exemplary reminder message about an imminent targeted event sent to a cellular telephone.

FIG. 5 shows an exemplary data flow diagram in an exemplary software operation.

FIG. 6 shows an exemplary process to provide a remote check-in reminder for a user to attend a target such as a flight check-in.

### DESCRIPTION

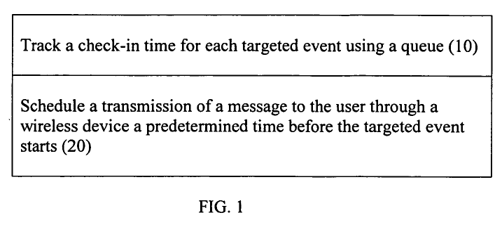

FIG. 1 shows an exemplary process to provide remote check-in for one or more targeted events for a user. The process receives a check-in time for each event, for example, a flight time or a lunch reservation time. The process tracks the check-in time for each targeted event using a queue (10). This is done using an event database to track a check-in time for each targeted event and a queue receiving data from the event database and having one entry for each targeted event. Next, the process schedules a transmission of a message to the user through a wireless device a predetermined time before the targeted event starts (20). This is done with a scheduler coupled to the event database and the queue. In one embodiment, the scheduler sends a message to the user through a wireless device a predetermined time before the targeted event starts.

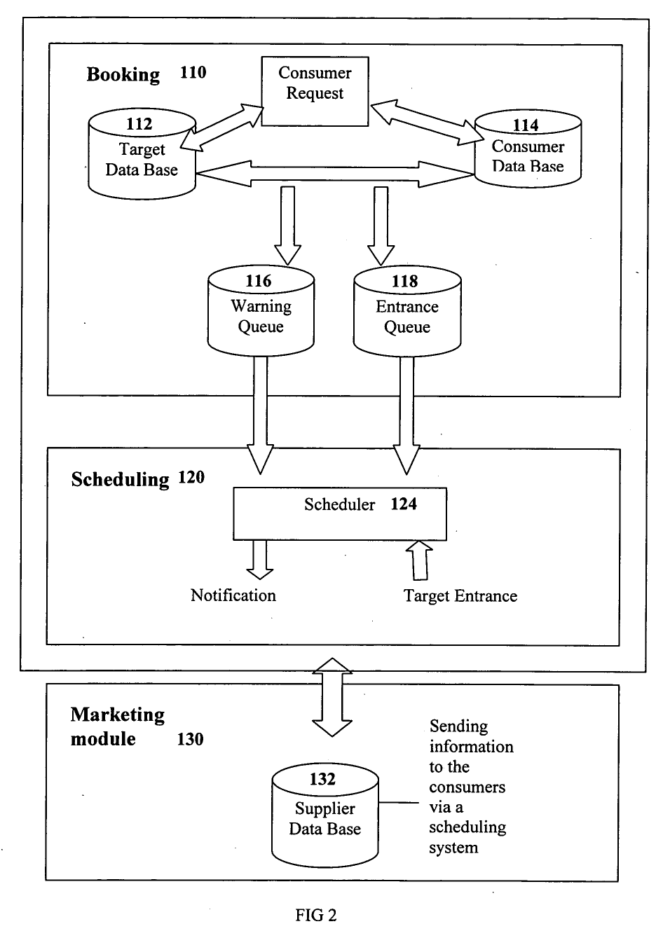

FIG. 2 shows an exemplary system to provide remote check-in for users. The system has three units: a booking unit 110, a scheduling unit 120 and a marketing unit 130. The booking unit 110 has a first database 112 containing target event data and a second database 114 containing consumer data. The booking unit 110 has a warning queue 116 and an entrance queue 118, both of which communicates with a scheduler 124 in the scheduling unit 120. The scheduler 118 receives target entrance data and sends notification to the user through wireless communication techniques such as SMS or WiFi, WiMAX, and Bluetooth, among others. The scheduling unit also communicates with the marketing module 130 which includes a supplier database 132. The supplier database provides location and timing information, among others, to assist the scheduler 124 in placing appropriate value-added information on the user's wireless device such as targeted advertisements, among others.

The target data is stored in the data base holding information about the targets known to the system. In one implementation, for each target the following data is stored:

Target Identification
Target position geographical
Calendar of capacity for System Target

(From YYYY.MM.DD.HH.MM To YYYY.MM.HH.MM,

Capacity per time unit)

For example,
from 2005.09.20.08.00 To 2005.09.20.15.59 capacity is
100/hour
from 2005.09.20.16.00 To 2005.09.21.07.59 capacity is
0/hour

Link to the warning queue for target
Link to the entrance queue for target

For each consumer, the following consumer data is stored

System User Identification
Cell Phone Number
Other handheld mobile devices number
e-mail address
Credit Card data
Demographical Data

Age
Male/Female
Home Address
Interests

Cultural
Shopping
Business
Preferred form of transportation

Link(s) to entrance(s) in the entrance queues
Link(s) to warnings(s) in the warning queues

In one implementation, the system defines a ‘Target’ as a place in front of which a queue of people normally exists. A target could be a check-in at airports, at immigration offices, or at sight-seeing spots such as a walk up the Eiffel Tower in Paris or a boat tour of Alcatraz in San Francisco, among others. In this implementation, the user can book a place on a virtual queue using an internet connection or cell-phone based connection. The system tracks the time and sends the user a reminder a various preselected intervals. For example, the user can receive on his or her cell-phone an SMS message about 30 minutes prior to his or her expected arrival at the targeted event. The system can send the user another reminder about 15 minutes prior to the expected arrival at the targeted event.

The system provides precise information for marketing purposes as it holds data about people, where they are going and when. Based on the location, the system could suggest the user how to better use the time waiting for the next targeted event. For example, the system can recommend local restaurants and other attractions close to the targeted event such as shops and transportation services, among others. The system can also provide additional value-added information to the user such as changes in travel plan, i.e. gates and terminals, cancellations, wake-up calls, route descriptions, among others.

For each Target one queue of warnings is updated, where each queue element holds the following data:

System user identification

Time of warning

Message to be send

Similarly, for each Target one queue of entrance elements is updated, where each queue element holds the following data:

System user identification

Expected time slot for entrance

The administration of the target allows targets to be created, deleted, or modified. The calendar is a set of data telling which capacity is at any point of time reserved for system queue consumers. The calendar is used in order to give good service to the costumers and to keep a good flow at the target. The administrator of the target knows the capacity at the target at any given time. For example, the capacity of check-in at an air port is 1.000 passengers per hour on Friday evenings between 5 μm and 7 μm, while capacity on Sunday mornings between 5 am and 7 am is 100 passengers per hour. In order not to create more entrances in the entrance-queue than the capacity is, granting a time slot to a user is subject to free capacity. Therefore the calendar of each target holds information about the capacity of the target at any given time.

Similarly, the administration of the consumers is done as an application where information about consumers is created, deleted and modified. The consumers are linked to the targets through the queues.

When a consumer books a time slot for entrance to a target event the following processes take place:
The consumer demands a time slot.
The entrance queue of the target is analyzed, if there is free capacity, the user is granted this time slot
If no capacity is available, the consumer is suggested nearest free time slots.

When the consumer accepts a granted time slot, one or more warning elements are added to the warning queue and an entrance element is added to the entrance queue. One warning element for each warning is added, and one entrance element is added.

The scheduler analyzes all queues by the following never ending process:
For each queue the first element of the queue is analyzed, giving the time for first coming warning.
When it is time for the warning, the scheduler notifies the consumer, and removes the element from the queue.

When the user is registered at the entrance to the target, the scheduler is notified, and the corresponding element of the entrance queue is removed.

Suppliers known to the system can offer products and services to the consumers. These offerings are presented to the consumers, and the offerings depend on the geographical position of the target, time of day, time of year, the demographical data of the consumer, the amount of time the consumer has before entrance, among others. The marketing module is a very general tool based on a set of behavioral information, which can be combined in many ways.

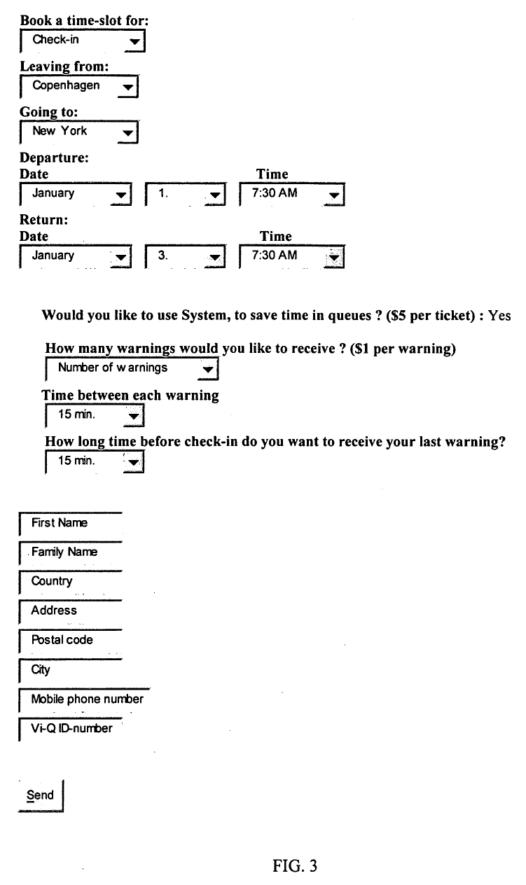

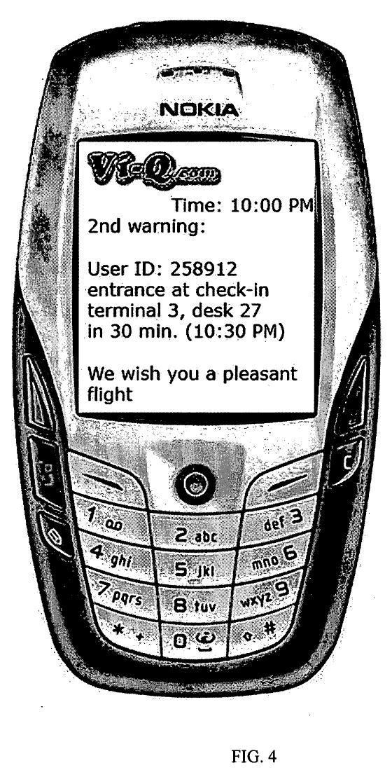

FIG. 3 shows an exemplary user interface (UI) to capture relevant information about a targeted event. The UI captures information to book a time-slot for a particular event. The UI queries the trip start location (Leaving From) and the destination location (Going To), the departure time, and the return time. The system then checks for payment option when the system is used to save time in queues and incremental costs per warning. The system also collects time between each warning, as well as the period before check-in to receive your last warning. Once the user completes the information, he or she can click on the “Send” button to submit the information to the scheduler. Upon reaching a warning time, the scheduler sends a message to the user to alert the user of the impeding check-in. FIG. 4 shows an exemplary reminder message about an imminent targeted event sent to a cellular telephone.

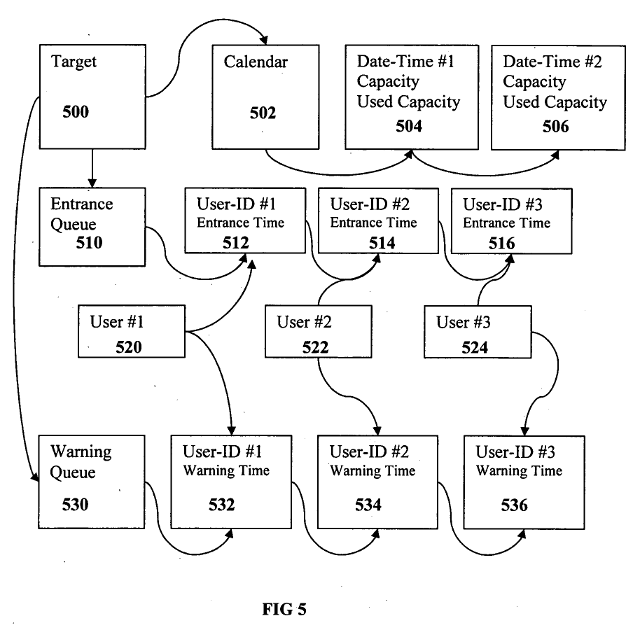

FIG. 5 shows an exemplary data flow diagram in an exemplary software operation of the above data structure and processes. In FIG. 5 is illustrated an exemplary structure with one target 500 and users 520, 522 and 524. A calendar 502 for the target 500 has two elements 504-506 showing the capacity at time #1 and the capacity at time #2. The target 500 is linked to an entrance queue 510 of the target 500 and linked to a warning queue 530 of the target 500. The entrance queue 510 has three elements 512-516 for User #1, User #2 and User #3, each being granted access to the target 500. The warning queue 530 also has three elements 532-536 for Users #1-User#3. Each of User #1, User #2 and User #3 will have one warning send out at a particular warning time indicated in the corresponding elements in the warning queue 530.

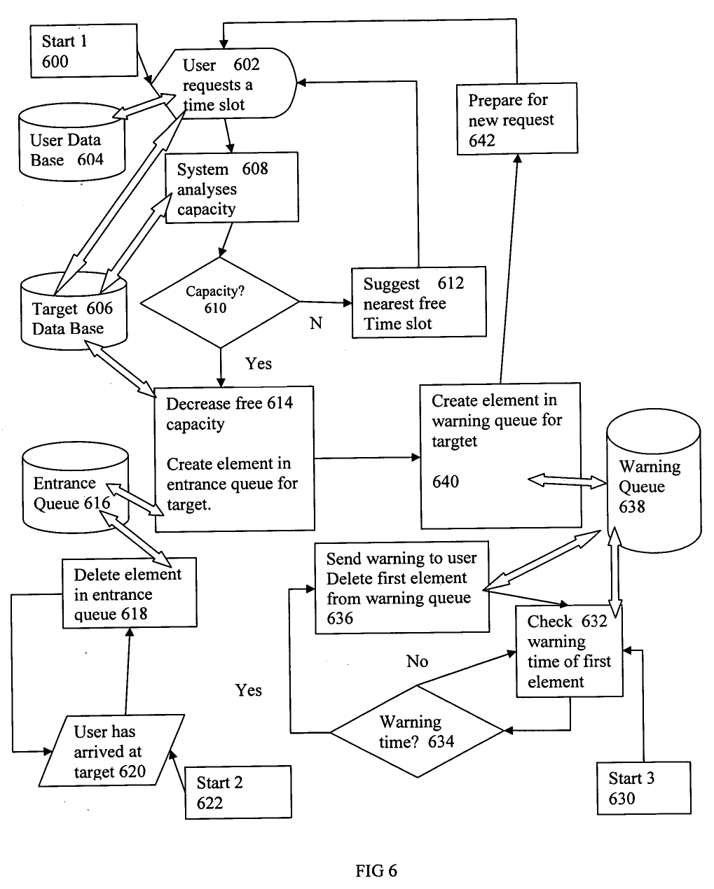

FIG. 6 shows one exemplary implementation of a wireless reminder system 600. First, a user requests a time slot (602). The user request is used to look up a user data base 604 and a target data base 606. The system analyzes the capacity of the target (608). The system checks for capacity in 610. If there is no capacity, the system suggests a nearest free time slot 612 and loops back to 602. Alternatively, if capacity exists at the target event, the system decreases the free capacity of the target and creates an element in an entrance queue 616 for the target (614) and also creates an element in a warning queue 638 for the target (640). Next, the system prepares for a new request (642) and loops back to 602 to continue processing.

The entrance queue 616 is also looked up when the user arrives at the target. From the second start 622, when the user arrives at the target in 620, the system deletes the element created in 614 in the entrance queue 616.

If the time for the event has not elapsed, from the third start 630, the system checks for a warning time of the first element in a warning queue 638 (632). Next, the system checks whether it is time for a warning message (634). If not, the system loops back to 632. Alternatively, if it is time for a warning, the system sends the warning to the user and deletes the first element from the warning queue 638 (636).

The above aspect or embodiment can be varied in many ways as will be apparent to those of ordinary skill in the art. Other information include weather information specific to the region, locations of public telephones within the region, retail shops or malls within the regions, among others. For example, relating to retail shops or malls for example, customer or user profiles for users of wireless mobile units can be stored in the supplier database. The profiles may include, for example, specific items a user likes to shop for, such as antiques, for example. Then, as the user enters a region or cell containing stores matching the profile, such as antique stores for example, information is output to the wireless device indicating such stores within the region; and optionally indicating locations of such stores within the region. It should be understood that this aspect can be used to target any designatable thing or category of things within a region including, but not limited to restaurants, health clubs, bars, banks, etc. In addition, the aforementioned aspects of route determination and map matching can also be applied to illustrate travel routes to targeted events or places.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A system to provide remote check-in for one or more targeted events for a user, comprising:
an event database to track a check-in time for each targeted event;
a queue coupled to the event database and having one entry for each targeted event;
a scheduler coupled to the event database and the queue, the scheduler sending a message to the user through a wireless device a predetermined time before the targeted event starts.

2. The system of claim 1, wherein the wireless device comprises one of: a cellular telephone, a wireless personal computer, a wireless personal digital assistant.

3. The system of claim 1, wherein the wireless device comprises one of an 802.11 device, a Bluetooth device.

4. The system of claim 1, wherein the message comprises an SMS message,

5. The system of claim 1, wherein the message comprises spoken information.

6. The system of claim 1, wherein the message comprises an e-mail.

7. The system of claim 1, comprising a supplier database coupled to the event database to send additional information to the user.

8. The system of claim 7, wherein the additional information comprises a targeted advertisement.

9. The system of claim 7, wherein the additional information comprises location based information.

10. The system of claim 7, wherein the additional information comprises time based information.

11. A method to provide remote check-in for one or more targeted events for a user, comprising:
tracking a check-in time for each targeted event using a queue; and
scheduling a transmission of a message to the user through a wireless device a predetermined time before the targeted event starts.

12. The method of claim 1, wherein the wireless device comprises one of: a cellular telephone, a wireless personal computer, a wireless personal digital assistant.

13. The method of claim 1, wherein the wireless device comprises one of an 802.11 device, a Bluetooth device.

14. The method of claim 1, wherein the message comprises an SMS message.

15. The method of claim 1, wherein the message comprises spoken information.

16. The method of claim 1, wherein the message comprises an e-mail.

17. The method of claim 1, comprising sending additional information to the user without user request.

18. The method of claim 17, wherein the additional information comprises a targeted advertisement.

19. The method of claim 17, wherein the additional information comprises location based information.

20. The method of claim 17, wherein the additional information comprises time based information.
